(19) United States
(12) Patent Application Publication
(10) Pub. No.: US 2011/0056959 A1
(43) Pub. Date: Mar. 10, 2011

(54) Cold Gas Generator

(76) Inventor: Martin Haege, Boenningheim (DE)

(21) Appl. No.: 12/225,278

(22) PCT Filed: Feb. 2, 2007
(86) PCT No.: PCT/EP2007/000907

§ 371 Date: Nov. 15, 2010

(30) Foreign Application Priority Data
Mar. 17, 2006 (DE) 10 2006 012711.0

(51) Int. Cl. F17C 1/00

(52) U.S. Cl. 220/581

(57) ABSTRACT

The invention relates to a cold gas generator with a pressure tank (1), which can be filled with compressed gas and comprises a closed base at one end and a tank opening at the other end, wherein an electrically drivable closure device can be inserted into the tank opening, which closure device is energized in a working position and opens an outlet opening of the closure device.

The invention relates to a gas generator in accordance with the precharacterizing clause of Claim 1.

Cold gas generators are known which comprise a pressure tank, in which the cold gas is stored under pressure, and a nozzle, through which the compressed gas can escape if the outflow openings are released by an opening mechanism.

Usually, this opening mechanism comprises a diaphragm, which is fixedly connected to the gas pressure tank and thereby closes a central outflow opening. This diaphragm is usually destroyed by an ignition mechanism or a suitable mechanism, with the outflow opening being released.

Pyrotechnics are often used for this ignition mechanism. They produce a short-term high pressure, which destroys the closure diaphragm, as is described in EP 1 561 649 A1, in EP 1 319 558 B1 or in EP 1 424 246 A1. EP 1 294 592 B1 describes a mechanical device which supports the diaphragm in the rest state and, as a result of the effect of a pyrotechnic charge, eliminates this support, as a result of which the diaphragm is destroyed and the opening is released. It also arises that the closure diaphragm could be destroyed in an undefined manner, as a result of which the outflow opening is blocked. In order to prevent this, complex constructions are often used.

The prior art has a few problems. A complex manufacturing device is always required which is used to connect the closure diaphragm to the pressure tank. In addition, it is necessary to connect the triggering device itself in a sealtight manner to the pressure tank via a complex manufacturing device in order to prevent the pyrotechnic gas from escaping in an uncontrolled manner after the ignition. The filling device has a very complex design and often needs to contain the device for closing the pressure tank in a sealtight manner. A significant disadvantage of the prior art is the fact that a functional check and therefore quality control in advance is not possible. A further disadvantage consists in the fact that the cold gas generator cannot be reused once it has released gas or can only be filled again after complex repair work with a complex filling device and then reused.

The invention is therefore based on the object of providing a cold gas generator which makes it possible, in advance, prior to installation, to carry out a functional check of the opening function and which manages without ignition by means of pyrotechnic gas.

This object is achieved according to the invention by the features of Claim 1. Further advantageous configurations and developments are specified in the further claims.

The configuration according to the invention of an electrically drivable closure device which can be used in a tank opening of a pressure tank has the advantage that the closed position and working position can be checked prior to installation in a pressure tank in a test device. This ensures that only operable closure devices are used for a cold gas generator. Furthermore, the electrically drivable closure device has the advantage that, by means of the closure device being energized, it is possible to drive a working state or a working position, as a result of which the outlet opening can be set with respect to the quantity of a compressed gas which is capable of flowing out or is capable of being introduced. As a result, firstly the quantity of gas intended to flow out can be driven if necessary. This makes it possible, for example, for a discontinuous or intermittent outflow and an increasing or decreasing quantity of outflowing gas to be capable of being driven for the respective application case. Furthermore, the energization can also be used such that targeted filling or refilling is possible. The closure device which can be inserted into the tank opening of the pressure tank furthermore has the advantage that it is reusable and the individual components can be recycled.

An advantageous configuration of the invention provides that the closure device has a cover, which can be inserted, in particular detachably, into the tank opening in a media-tight manner. This makes a simple closure of the pressure tank possible. For example, a screw connection is provided which withstands the pressure applied in the pressure tank and closes in a media-tight manner. Alternatively, compression or welding and also flanging of the tank edge can also be provided in order to hold the cover securely.

A further advantageous configuration of the invention provides that the closure device has an outlet opening for compressed gas between the cover and a body, preferably a rotationally symmetrical body, which outlet opening can be opened by an electrically drivable expanding element with a gap being produced between the cover and the body when the expanding element is energized. As a result, a compact design of the closure device can be achieved which is provided in a pressure tank. Furthermore, a simple configuration in design terms is provided which likewise makes simple and cost-effective manufacture and assurance a high level of quality possible.

The electrically drivable expanding element is preferably provided in the rotationally symmetrical body. As a result, simple force ratios can be provided in order to drive an opening cross section, preferably in the tenths of a millimetre range, between the rotationally symmetrical body and the cover.

Furthermore, it is preferably provided that the rotationally symmetrical body is held on the cover in a closed position by means of a spring element, which is arranged under prestress, with a fastening element. As a result of this contact-pressure force, a sealtightness of the outlet opening in a rest position is achieved. At the same time it is possible to ensure that opening of the outlet opening can only be achieved after a predetermined adjustment path or working travel of the expanding element.

In order to increase the sealing pressure and in order to at the same time position the rotationally symmetrical body centrally with respect to the cover, it is preferably provided that a circular rib with a circular groove acting thereon is provided between the cover and an end side, resting thereon, of the rotationally symmetrical body. The groove can be provided both on the cover and on the end face of the rotationally symmetrical body.

Furthermore, a suitable seal made from flexible material for sealing off the outlet opening in a closed position of the closure device can preferably be inserted between a lower side of the cover and the end-side edge of the rotationally symmetrical or pot-shaped body.

Preferably, an annular gap is provided between an inner wall of the pressure tank and the inserted closure device in order that the compressed gas can flow to the outside through the outlet opening when required.

For simple filling, it can preferably be provided that an actuating apparatus is formed which acts mechanically on the fastening element, which fixes the rotationally symmetrical body in a media-tight manner to the cover, in order that the compressed gas can be introduced into the pressure tank through the outlet opening.

Alternatively, the actuating apparatus can energize the closure device during the filling operation, as a result of which the expanding element holds the closure device in an open position.

In accordance with a further preferred embodiment of the invention, it is provided that a holding element is provided on an outer circumference of the pressure tank, which holding element is provided for positioning an airbag, an object which can be filled with a pressure medium or a filling device.

The above-described cold gas generator can be used in a wide variety of ways universally both as a mobile device and as a stationary device owing to the configuration according to the invention of the electrically drivable closure device. Mobile use areas are, for example, airbags in vehicles or else in areas with little accommodation space. In this case, the airbag itself can be mounted in this area and can have a feed line to the cold gas generator which is accommodated at a distance. Examples of efficiently closer devices are closure systems which permanently close safety-sensitive devices in a short period of time in emergencies in the case of an alarm in order, for example, to protect values, to prevent contamination or the outflow and ingress of water or liquids. These closure devices according to the invention in cold gas generators can then generally be opened by authorized personnel at the end of the emergency or once their use has come to an end and be reset to an active state.

The invention and further advantageous embodiments and developments thereof are described and explained in more detail below with reference to the example illustrated in the drawing. The features given in the description and shown in the drawing can be used individually per se or in any desired combination of two or more in accordance with the invention. In the drawing:

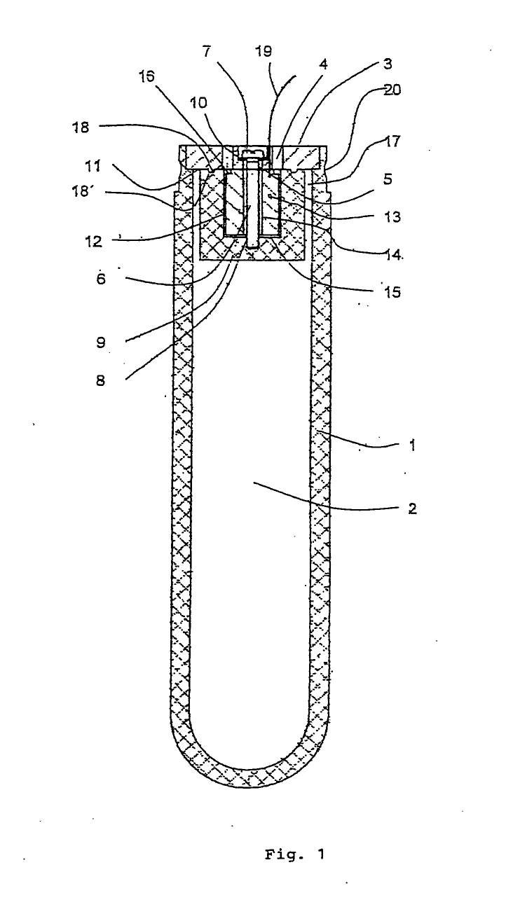

FIG. 1 shows a schematic sectional illustration of a cold gas generator with a closure device according to the invention.

FIG. 1 shows a schematic sectional illustration of a cold gas generator with a closure device according to the invention.

A pressure tank 1 is closed at the open end by a cover 3. This can take place by means of it being welded to the pressure body 1 or else by means of a sealtight screw connection. In addition, the outer edge of the pressure body 1 is configured in such a way that either the nozzle of an airbag or an application-specific device can be attached in a sealtight manner and filled by means of the cold gas generator. In order to fill the pressure tank 1, it is possible to replace the nozzle of the airbag or the attached device with a filling device and to attach this at the edge. An example of a simple solution for the detachable fastening of a nozzle is a sealtight screw connection.

The cover 3 also acts as a holder for the remaining components of the closure device of the cold gas generator. The entire closure device therefore comprises the cover 3 itself, a rotationally symmetrical, preferably pot-shaped body 9, a pin 6 with a head 7 and an expanding element 13. This closure device can be prefabricated in a simple manner prior to final assembly and tested easily in a suitable test device without the pressure tank 1 needing to be attached, as a result of which a very high degree of operational reliability and quality assurance can be ensured.

The cover 3 has outflow openings 4, through which the compressed gas 2 can flow out or can be introduced into the pressure tank 1. A recessed bore or stepped bore 5, through which a pin 6 with a head 7 protrudes inwards, is in the centre of the cover 3. This pin 6 could also be a screw 6. A rotationally symmetrical body 9, which in this case is, for example, in the form of a pot-shaped body 9 whose upper edge is pressed against the lower side 11 of the cover 3 outside the outlet openings 4 of the cover 3, is fastened on the lower end of the pin 6. The required sealing pressure is provided by a spring element 10, in particular a disc spring, which is arranged between the cover 3 and the head 7 of the pin 6 in the embodiment illustrated. This sealing pressure required for the sealtightness of the closed cold gas generator is assisted by the compressed gas 2 itself, whose pressure acts on the base of the pot-shaped body 9. The pot-shaped body 9 does not fill the entire inner diameter of the pressure tank, but leaves an annular region or annular gap 17 free, in which the compressed gas 2 is likewise located. It is therefore not necessary for the pot-shaped body 9 and the pressure tank 1 to especially fit with one another, which simplifies manufacture and assembly and at the same time avoids friction. The cover 3 could advantageously have an annular rib 18 at its edge, which rib 18 is pressed against the edge of the pot-shaped body 9 and, as a result of the thus higher sealing pressure in comparison with a design in which they bear flat against one another, ensures an increased level of sealtightness. Furthermore, a groove 18′, which is provided at the edge of the pot-shaped body 9 and corresponds to the rib 18, is advantageously used for centering the pot-shaped body 9. It is also conceivable that this rib 18 is fitted at the edge of the pot-shaped body 9 and the groove is fitted on the lower side 11 of the cover 3. Another possibility which is not illustrated would be for a sealing element made from a flexible material to be used as an inlay, as a result of which any irregularities between the cover 3 and the pot-shaped body 9 could be compensated for and the sealtightness is once again increased. Another possibility for centering the pot-shaped body would be, for example, short radial ribs (not illustrated) on the outer diameter of the pot-shaped body 9 which bridge the interspace with respect to the inner wall of the pressure tank 1.

An expanding body 13 is arranged around the pin 6 within the pot-shaped body 9 and the screw 6 is plugged through the central bore 14 of said expanding body 13 and thereby centres it and fills the height between the base 15 of the pot-shaped body 9 and the lower side 11 of the cover 3 with a small amount of play. On the upper side, the expanding body 13 is configured, for example, by means of a stepped edge 16 in such a way that the outflow openings 4 of the cover 3 are free. This expanding body 13 is connected, through the cover 3, to a power supply via insulated electrical lines 19. By means of this electrical connection, the expanding body 13 can be activated by suitable energization in a very short period of time so as to cause it to expand. The expanding body 13 is supported as it expands longitudinally between the lower side 11 of the cover 3 and the base 15 of the pot-shaped body 9. In this case, these electrical lines 19 are connected, for example, to a suitable contact (not illustrated) on the cover 3, which contact corresponds to corresponding contacts of the attached nozzle of the application-specific device or the filling device, or the lines are simply connected to the power supply of these devices via plug-type connectors. Since the pot-shaped body 9 seals off the compressed gas in the pressure tank 1, it is not necessary to guide the electrical lines 19 in a sealtight manner through the cover 3, as a result of which the design is additionally simplified. The expanding body 13 can be in the form of, for example, a multilayered piezoelectric element. Other thermal expanding bodies 13 or materials with memory effect can be heated severely for a short period of time by high currents in order to achieve the desired longitudinal expansion.

If the expanding body 13 is now energized, it lifts the pot-shaped body 9 away from the cover 3 counter to the gas pressure and the spring element 10, with the result that a small gap of an order of magnitude of 1/100 to 1 mm, in particular approximately 1/10 millimetre is formed between the lower side 11 of the cover 3 and the edge of the pot-shaped body 9. This gap produces a connection between the outflow openings 4 of the cover 3 and the annular gap 17 between the pot-shaped body 9 and the inner diameter of the pressure tank 1, with the result that the compressed gas 2 can escape. The height of the gap and the diameter of the overflow edge of the pot-shaped body 9 give the throughflow cross section for the outflowing compressed gas 2. This results in a wealth of adjustment possibilities by virtue of it being possible for the outflow time of the compressed gas to be fixed depending on the application by means of the selection of the diameter of the pot-shaped body 9 and the height of the gap as well as the size of the outflow openings 4.

Once the compressed gas has flowed out and the energization of the expanding body 13 has come to an end or the expanding body 13 has cooled down and has retracted again, the pot-shaped body 9 returns to its initial position as a result of the force of the spring element 10. In principle, the cold gas generator is therefore again ready to be filled. For this purpose, the nozzle of the airbag or of the application-specific device is removed from the cold gas generator and replaced with a filling device. This does not require any special manufacturing device, with the result that this filling operation can in principle be carried out at the location of the device.

There are in principle two different possibilities for the filling operation. Once the nozzle of the filling device has been attached in a sealtight manner to the cold gas generator, the pressure tank 1 can be opened mechanically, for example, by virtue of the pot-shaped body 9 simply being pressed downwards against the spring element 10 via the pin 6, as a result of which the gap between the lower side 11 of the cover 3 and the edge of the pot-shaped body 9 opens. Another possibility is to energize the expanding body 13, which then likewise opens the gap. Once the pressure tank 1 has been opened in one of the described ways, the compressed gas 2 can be introduced by means of opening a valve of the filling device.

Depending on the application and the use location, various devices can be used for the filling operation. The filling operation is possible, for example, by means of a cartridge filled with compressed gas 2 which is available to the user of the cold gas generator from a warehouse and is inserted into a suitable holder, which is connected to the nozzle of the cold gas generator. One disadvantage here is generally the fact that the cartridge can only be used once. Another possibility would be to carry out the filling operation by means of a high pressure pump. However, this presupposes that the high pressure pump and the required gas are available to the user in a suitable form or that the cold gas generator is removed from the application-specific device in order that it can be filled on the premises of a company which has the suitable device.

It is also conceivable that the filling device is filled with a precisely defined quantity of liquid gas which flows, without any pressure being applied, by the force of gravity into the cold gas generator, changes its state of aggregation there by means of naturally being heated up and thus builds up the required gas pressure. As in the case of all cryogenic gases, one disadvantages are that, owing to the generally very low temperatures, special knowledge is required for handling the gases if, for example, it is intended to prevent freezing as a result of air humidity, and that the filling device needs to be insulated well in order that there is sufficient transportation time between the liquid gas manufacturer and the user. The filling device is therefore also not available to the user from a warehouse. The filling operation also requires a defined setting of the cold gas generator and prior evacuation thereof in order to prevent the cold gas from mixing with air.

A particularly simple embodiment is provided if the filling device has a similar design to that of the cold gas generator itself. Then, the filling device is opened at the same time as the cold gas generator by means of the expanding body 13 being energized or by means of the spring-loaded pins 6 being mechanically actuated, with the result that a pressure equilibrium is set between the filling device and the cold gas generator, and this pressure equilibrium corresponds to the required rated pressure of the cold gas generator, before the filling device and the cold gas generator are closed again. Such a filling device can be made available to the user from a warehouse. This type of filling operation also has the cost advantage resulting from the reusability of the filling device once it has been refilled on the premises of the manufacturer. Such a filling device can also contain a multiple of the quantity of gas required for the cold gas, with the result that a plurality of cold gas generators can be filled with a single filling device. This is primarily very advantageous when, for example, a closure system has activated a plurality of such cold gas generators.

All of the above-described features are each per se essential to the invention and can be combined with one another as desired.

1. Cold gas generator with a pressure tank, which is fillable with compressed gas and comprises a closed base at one end and a tank opening at the other end, an electrically drivable closure device is insertable into the tank opening, which closure device is energized in a working position and opens an outlet opening of the closure device, characterized in that the closure device has an outlet opening for compressed gas between a cover and a body, which outlet opening is openable by an electrically drivable expanding element by virtue of a gap being produced by the expanding element between the cover and the body.

2. Cold gas generator according to claim 1, characterized in that the closure device has a cover, which is fittable into the tank opening in a media-tight manner.

3. Cold gas generator according to claim 1, characterized in that the closure device has a cover which is detachably fitted into the tank opening.

4. Cold gas generator according to claim 1, characterized in that the expanding element is provided in the body, which is preferably in the form of a pot.

5. Cold gas generator according to claim 3, characterized in that the body is held on the cover in a closed position by means of a spring element, which is arranged under prestress, with a fastening element.

6. Cold gas generator according to claim 1, characterized in that the cover has, on its lower side, a circular rib, which corresponds to a likewise circular groove at the edge of the pot-shaped body, in particular the depth of the groove being slightly smaller than the height of the rib.

7. Cold gas generator according to claim 1, characterized in that a suitable seal made from a flexible material for sealing off the outlet opening in a closed position of the closure device is introduced between the lower side of the cover and the edge of the pot-shaped body.

8. Cold gas generator according to claim 1, characterized in that an annular gap is located between the pot-shaped body and the inner wall of the pressure tank.

9. Cold gas generator according to claim 8, characterized in that longitudinal ribs are provided in the annular gap between the pot-shaped body and the inner wall of the pressure tank, by means of which longitudinal ribs the pot-shaped body is kept centered, in particular the longitudinal ribs acting on the body with a small amount of play.

10. Cold gas generator according to claim 1, characterized in that a pin with a head, preferably a screw, is provided which is connected to the body, in particular by means of a blind thread, and holds an expanding element.

11. Cold gas generator according to claim 10, characterized in that the pin is fixedly connected to the pet-shaped body or is an integral component thereof, and the head is in the form of a nut, which is screwed onto a thread at the end of the pin.

12. Cold gas generator according to claim 11, characterized in that insulated electrical lines, which are arranged on an expanding element, are passed to the outside through the cover.

13. Cold gas generator according to claim 10, characterized in that the closure device is openable by means of an actuating apparatus, which acts mechanically, by means of pressure, on the head of the pin or energizes the expanding element.

14. Cold gas generator according to claim 1, characterized in that, on the pressure tank, an airbag or an application-specific device and a filling device is fittable in a media-tight manner on the sealtight fastening option.
